(19) United States
(12) Patent Application Publication
(10) Pub. No.: US 2026/0035966 A1
(43) Pub. Date: Feb. 5, 2026

(54) FORCED ENTRY RESISTANT ACCESS CONTROL DEVICES

(71) Applicant: Schlage Lock Company LLC

(72) Inventors: Alexander Stone Kao, Indianapolis, IN (US); Paul R. Arlinghaus, Fishers, IN (US)

(21) Appl. No.: 19/285,256

(22) Filed: Jul. 30, 2025

Related U.S. Application Data
(60) Provisional application No. 63/677,232, filed on Jul. 30, 2024.

(51) Int. Cl. E05B 65/10

(52) U.S. Cl. CPC E05B 65/1053

(57) ABSTRACT

An access control device is provided for maintaining deadlocking features, even when the access control device is struck by a projectile discharged from a weapon. An exit device of the access control device can include at least one shield housing configured to retain the orientation of a main control link assembly in a manner that prevents deactivation of deadlocking capabilities. A trim assembly of the access control device can include at least one armor body, constructed of hardened steel, housed within a trim portion of the trim assembly. The armor body is positioned to at least minimize, and potentially prevent, damage to components such as the latch return spring caused by impact from the discharged projectile. Optionally, one or more armor bodies may also be mounted directly to the exit device, including, for example, on a baseplate, to provide further protection for components of the main control link assembly.

### TECHNICAL FIELD

The present disclosure generally relates to access control devices, and more particularly, but not exclusively, to forced entry resistant access control devices.

### BACKGROUND

Access control devices can be installed on doors to provide for egress from an area. At least certain types of access control devices can include a pushbar assembly mounted to an egress side of a door that can actuate a latch bolt to enable opening of the door from the egress side of the door.

In certain situations, illicit or unauthorized attempts may be made to actuate the latch bolt by damaging the access control device. For example, in situations involving individuals possessing a firearm, an individual may fire one or more bullets into the access control device in an attempt to forcibly gain entry to, or exit from, an associated room or building. Such bullets may be fired into the access control device in an attempt to have a bullet strike, and thereby damage or destroy, one or more components of the access control device that may otherwise assist in retaining the latch bolt in an extended, or locked, position. Accordingly, such damage or destruction of portions of the access control device by one or more bullets can be viewed by a potential intruder or harmful actor as a means to facilitate an unlocking of the access control device for opening the associated door so as to forcibly gain entry into, or illicitly escape from, the associated area(s).

### SUMMARY

The present disclosure may comprise one or more of the following features and combinations thereof.

In one embodiment of the present disclosure, an access control device is provided that can include a pushbar, a latch bolt that is displaceable between an extended position and a retracted position, a baseplate, and a main control link assembly positioned along the baseplate and coupled to the pushbar. The access control device can also include a shield housing having a cavity that extends through the shield housing. The shield housing can be coupled to the baseplate and can at least partially encompass a first portion of the main control link assembly within the cavity when the latch bolt is at the extended position. Further, at least a portion of the first portion of the main control link assembly can be displaced out from the cavity with a displacement of the latch bolt from the extended position to the retracted position. Additionally, the shield housing can be configured to retain an orientation of at least a portion of the main control link assembly relative to other components of the access control device in the event the main control link assembly is damaged by impact from a discharged projectile.

In another embodiment, a trim assembly for an access control device is provided that can include a trim portion constructed of a first material, the trim portion having a sidewall and a face wall, the sidewall extending around a perimeter of the trim portion. The face wall can extend across an upper portion of the perimeter of the trim portion. Further, the sidewall and the face wall define an interior area of the trim portion. The trim assembly can also include at least one armor body constructed of a second material that is different than the first material. The at least one armor body can be housed within the interior area of the trim portion and can be coupled to the trim portion by one or more mechanical fasteners. Additionally, the second material can be a hardened steel.

In another embodiment, an access control device is provided having an exit device and a trim assembly. The exit device can include a pushbar, a latch bolt that is displaceable between an extended position and a retracted position, a baseplate, and a main control link assembly positioned along the baseplate and coupled to the pushbar. The exit device can also include a shield housing having a cavity that extends through the shield housing. The shield housing can be coupled to the baseplate and can at least partially encompass a first portion of the main control link assembly within the cavity when the latch bolt is at the extended position. Further, at least a portion of the first portion of the main control link assembly can being displaced out from the cavity with a displacement of the latch bolt from the extended position to the retracted position. Additionally, the shield housing can be configured to retain an orientation of at least a portion of the main control link assembly relative to other components of the exit device in the event the main control link assembly is damaged by impact from a discharged projectile. The trim assembly can include a trim portion constructed of a first material, the trim portion having a sidewall and a face wall, the sidewall extending around a perimeter of the trim portion. The face wall can extend across an upper portion of the perimeter of the trim portion. Further, the sidewall and the face wall defining an interior area of the trim portion. The trim assembly can also include at least one first armor body constructed of a second material that is different than the first material. The at least one first armor body can be housed within the interior area of the trim portion and can be coupled to the trim portion by one or more mechanical fasteners. Additionally, the second material can be a hardened steel.

These and other features of the present disclosure will become more apparent from the following description of the illustrative embodiments.

### BRIEF DESCRIPTION OF THE FIGURES

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an exemplary representation of an access control device installed on a door.

FIG. 2 illustrates a perspective view of an exemplary exit device of an access control device.

FIG. 3 illustrates a side view of an exemplary baseplate assembly for the exit device shown in FIG. 2.

FIG. 4 illustrates a top view of a portion of the exemplary baseplate assembly shown in FIG. 3 but with a shield housing removed.

FIGS. 5A and 5B illustrate a perspective view and a cross sectional side view, respectively, of an interior portion of the exemplary access control device shown in FIG. 2.

FIGS. 6 and 7 illustrate first and second side perspective views, respectively, of an exemplary shield housing.

FIG. 8 illustrates a cross-sectional side view of the exemplary shield housing taken along line A-A of FIG. 6.

FIG. 9 illustrates a first end view of the illustrated exemplary shield housing.

FIGS. 10 and 11 illustrate rear side perspective and rear views, respectively, of an exemplary trim assembly of an access control device.

FIG. 12 illustrates a front view of the exemplary trim assembly shown in FIG. 10.

FIG. 13 illustrates a cross-sectional side view of the illustrated trim assembly taken along line B-B of FIG. 10.

FIG. 14 illustrates a rear side perspective view of an exemplary trim portion of the illustrated trim assembly.

FIG. 15 illustrates a rear view of an exemplary armor body of the illustrated trim assembly.

FIG. 16 illustrates a rear side perspective view of a second exemplary trim assembly.

FIG. 17 illustrates a cross-sectional side view of the second trim assembly taken along line C-C of FIG. 16.

FIGS. 18 and 19 illustrate rear side perspective views of the trim portion and armor body, respectively, of the second trim assembly shown in FIG. 16.

FIG. 20 illustrates a front side perspective view of another exemplary armor body for the trim assembly.

FIG. 21 illustrates a front view of the armor body shown in FIG. 20 positioned within an exemplary trim portion.

### DETAILED DESCRIPTION OF THE ILLUSTRATIVE EMBODIMENTS

The following Detailed Description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the Detailed Description is not meant to limit the embodiments described below.

In the Detailed Description herein, references to “one embodiment,” an “embodiment,” and “example embodiment,” etc., indicate that the embodiment described may include a particular feature, structure, or characteristic, by every embodiment may not necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one skilled in art to affect such feature, structure, or characteristic in connection with other embodiments whether or not explicitly described.

Embodiments of the subject disclosure provide a forced entry resistant access control device that can include both a trim assembly and an exit device. The access control device is configured to have at least a degree of resistance against damage to the access control device that may be caused by the access control device being subjected to an impact from a projectile, such as, for example, by a bullet shot from a firearm or other weapon. According to certain embodiments, such resistance provided by the configuration of the access control device can at least temporarily thwart and/or delay unauthorized passage through an associated entryway. In such instances, the resistance and/or delay afforded by the disclosed access control device can provide, if not extend, potentially crucial time to implement safety protocols, as well as aid in extending the time available for first responders to arrive at the location of the access control device to assist with a potentially dangerous situation.

The trim assembly and the exit device can be positioned on opposite sides of a door, or other entryway device. The trim assembly of the access control device can include a trim portion that is configured to provide an attachment point for the exit device. Additionally, as the exterior portion of the trim portion is typically the primary, if not only, visible portion of the trim portion assembly when the access control device is secured to the door, the trim portion is typically configured to be a decorative and visually pleasing component of the access control device. According to certain embodiments, the trim portion assembly is an exit only trim assembly, and thus does not include any openings or passageways for placement of key cylinders, levers, handles, or other components that may otherwise be used to facilitate displacement of a latch bolt of the access control device between an extended, or locked, position, and a retracted, or unlocked, position.

The trim assembly also includes one or more armor bodies, including, for example, plates, that are configured to absorb an impact from the projectile (e.g., bullet) launched from the weapon (e.g., firearm). Further, according to certain embodiments, the armor body(ies) can be generally positioned within a generally hollow cavity that can be defined by at least the trim portion. According to certain embodiments, the trim portion can be constructed from a first material, and the armor bodies may be constructed from a second material that is different than the first material. Additionally, the second material can, according to certain embodiments, have a material thickness that is larger than at least the corresponding material thickness of at least the first material at a location about the trim portion that is generally adjacent to the armor body. For example, according to certain embodiments, the first material can be a cast steel, bronze, or brass, among other cast materials, while the armor body can be a hardened steel plate that may have, for example, a material thickness of about ¼ inch, among other thicknesses.

The exit device can include a shield housing that covers or shields one or more components utilized in the displacement of a latch bolt of the access control device from such a launched projectile (e.g., bullet) from a firearm or weapon. Moreover, the shield housing can be configured, and positioned, to at least assist in attempting to ensure that latch deadlocking is maintained if the exit device is struck, including being shot, by a launched projectile (e.g., bullet) from a firearm or weapon. The shield housing can be selectively configured and/or positioned at one or more locations in an internal portion of the exit device over one or more components of the exit device that are, during typical operation of the exit device, displaceable in connection with the retraction of the latch bolt from an extended position to a retracted position, and/or vice versa, including, for example, a main control link spring, moveable linkage(s), and/or associated connectors or couplings, including, but not limited to, connector pins.

An access control device having features disclosed herein of either or both the trim assembly and the exit device can be configured to satisfy a variety of standards relating to at least forced-entry protection, including, for example, ASTM International standard ASTM F3561, among other standards, including, but not limited to prerequisite standards relating to ASTM F3561.

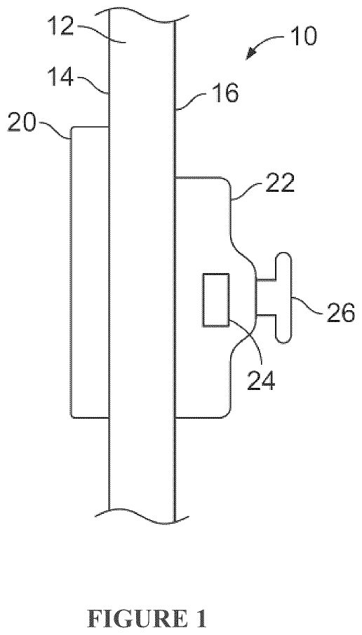

FIG. 1 illustrates an exemplary representation of an access control device 10 installed on a door 12. The door 12 generally includes a first side 14, such as, for example, a non-egress side, and an opposing second side 16, such as, for example, an egress side. When the door 12 is in its closed position, the first side 14 can face an exterior or outer region, and the second side 16 can face an interior or access-controlled region.

The access control device 10 generally includes a trim assembly 20 installed on the first side 14 of the door 12 and an exit device 22 installed on the second side 16 of the door 12. Additionally, one or more pathways between the first side 14 and the second side 16 can extend through the door 12 that can include, or provide areas for passage of, couplings, such as, for example, mechanical fasteners, including, but not limited to, bolts or screws, that can couple, including attach, the trim assembly 20 to the exit device 22. The illustrated exit device 22 includes a latch bolt 24 and a pushbar 26 operable to actuate the latch bolt 24. The trim assembly 20 can, according to certain embodiments, be an exit only trim assembly 20 in which the trim assembly 20 does not include, or house, any components utilized to selectively actuate the latch bolt 24 or used to adjust a locked or unlocked position of the latch bolt 24. Instead, according to certain embodiments, the trim assembly 20 can be a decorative element positioned on the first side 14 of the door 12 and utilized to provide an attachment point for the attachment of the exit device 22 to the door 12.

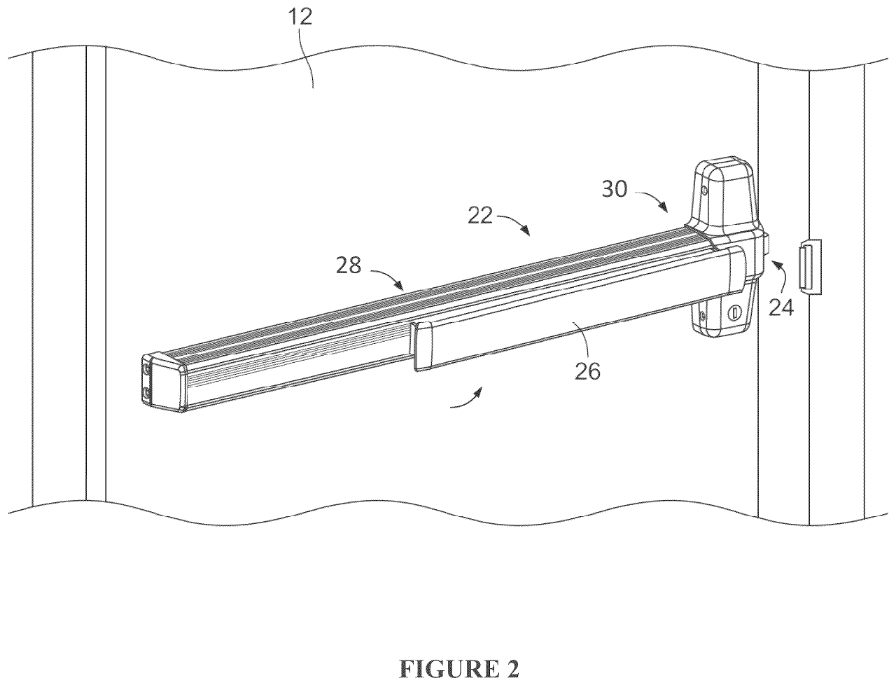

FIG. 2 illustrates an exemplary exit device 22 that can generally include a mounting assembly 28 and a center case assembly 30. The mounting assembly 28 can include a mounting plate the can abut, or generally be adjacent to, the second side 16 of the door 12 in a manner that can assist with mounting the exit device 22 to the door 12. The center case assembly 30 can be coupled, including indirectly coupled, to the pushbar 26 such that selective activation of the pushbar 26, including, for example, a depressing of the pushbar 26 generally toward the door 12, can result in the latch bolt 24 being displaced from an extended, or locked, position to a retracted, or unlocked, position.

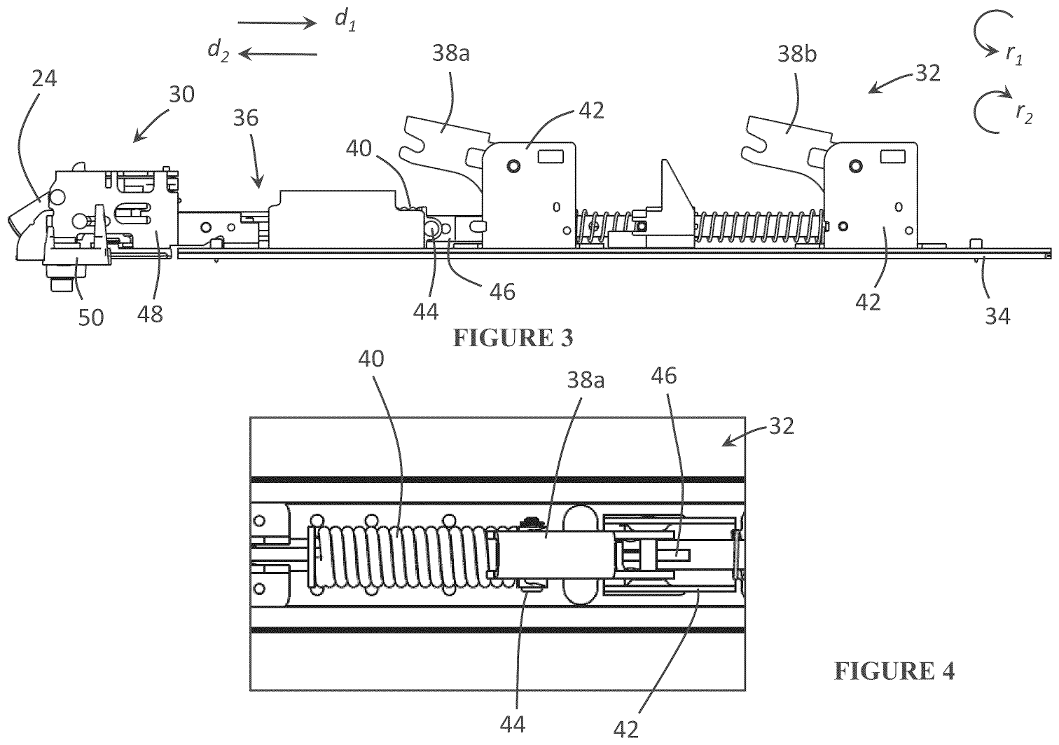

Referencing FIGS. 3-5B, an interior portion of the exit device 22 can house at least a portion of a baseplate assembly 32 of the exit device 22. According to certain embodiments, the baseplate assembly 32 can, in response to selective displacement of the pushbar 26, be operable to actuate the center case assembly 30, including withdraw the latch bolt 24 to the retracted, or unlocked, position. In the illustrated exemplary embodiment, the baseplate assembly 32 includes a baseplate 34, a main control link assembly 36, and at least one bell crank 38a, 38b. According to certain embodiments, the main control link assembly 36 can include a main control link spring 40 (FIG. 4) that can be coupled to one or more control linkage elements 46 of the main control link assembly 36. For example, according to certain embodiments, the main control link spring 40 can be coupled to a control linkage element 42 by a control pin 44.

The bell cranks 38a, 38b can be pivotally secured to one or more side plates 42 that extend from the baseplate 34, with the side plates 42 being operably secured to the baseplate 34, such as, for example, via one or more mechanical fasteners. According to certain embodiments, the bell cranks 38a, 38b can be directly or indirectly in contact with an inner portion of the pushbar 26. The main control link spring 40 and/or other biasing elements can assist in at least biasing the bell cranks 38a, 38b to a first position associated with the latch bolt 24 being at the extended, or locked position.

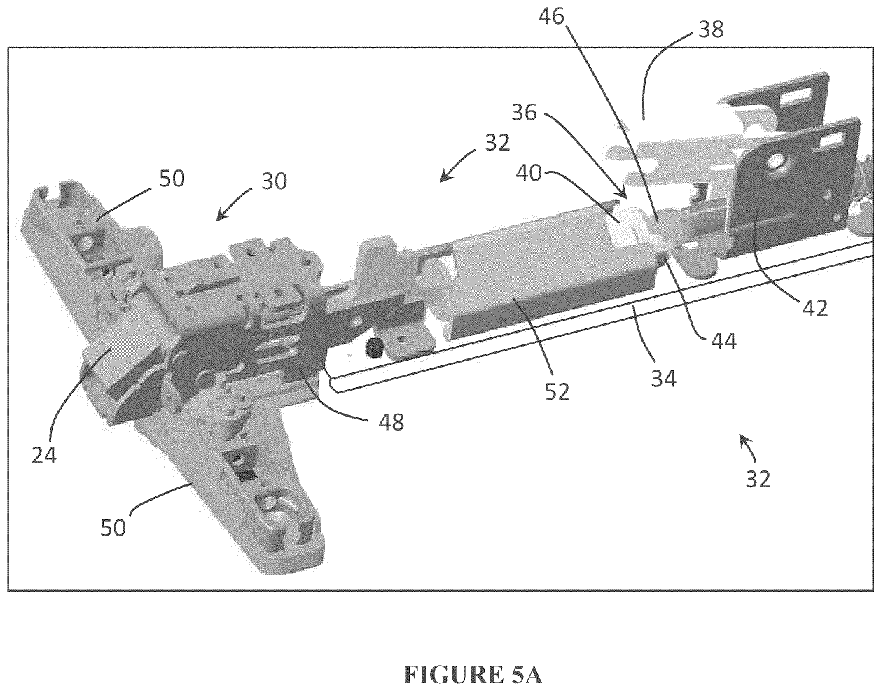

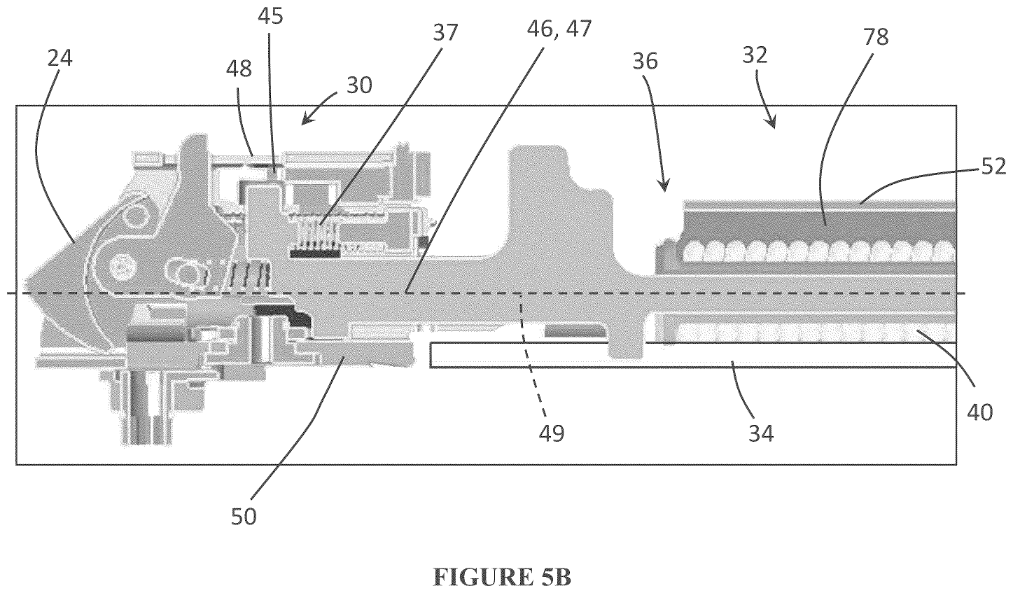

The center case assembly 30 can include a latch assembly that can include the latch bolt 24. The latch assembly is operably connected to the main control link assembly 36 such that, during typical everyday usage, the operable displacement of the pushbar 26 generally toward the door 12 may operate the latch assembly such that the latch bolt 24 may be displaced from a locked position to an unlocked position, thereby allowing opening of the door 12. As seen in at least FIG. 5B, the main control link assembly 36 can generally be oriented to extend along a central longitudinal axis 49 that is generally parallel to the baseplate 34. Additionally, as discussed below, during normal operation of the exit device 22, the main control link assembly 36 is configured to be linearly displaced in first and second directions (as generally identified by “d₁” and “d₂” in FIG. 3) in a manner that can provide a force to displace the latch bolt 24 between the extended, or locked, and retracted, or unlocked, positions.

The center case assembly 30 can also include a center case 48 coupled to a chassis 50, each of which can be constructed from a variety of materials, or combination of materials, including, for example, formed steel or cast steel, including, for example, 1018 cast steel, among other materials. The latch assembly can include the latch return spring 37, as seen in FIG. 5B, that can at least assist in biasing the latch bolt 24 to the extended, or locked, position. According to the illustrated embodiment, the latch return spring 37 can be positioned within the center case 48 at a position that is aligned with the chassis 50 and at least a portion of a control linkage element 46, including a main control link element 47 (FIG. 5B) of the main control link assembly 36. Moreover, the latch return spring 37 in the illustrated embodiment is positioned such that a projectile (e.g., bullet) discharged by a weapon (e.g., firearm) adjacent to the first side 14 of the door 12 toward the second side 16 of the door 12 at which the exit device 22 is mounted would have to pass through at least the door 12, the chassis 50, and the main control link element 47, among other components of the access control device 10, before reaching the latch return spring 37. Thus, such positioning of the latch return spring 37 relative to at least the chassis 50 and the main control link element 47 can provide the latch return spring 37 with a degree of protection or shielding from being struck by a projectile (e.g., bullet) fired by a weapon. As discussed below, the access control device 10 can include one or more armor bodies positioned about either or both the exit device 22 and the trim assembly 20 that can further enhance protection of at least the latch return spring 37 from potential damage caused by impact from a projectile launched from a weapon (e.g., a bullet shot from a firearm).

According to certain embodiments, the latch bolt 24 can be configured to engage a door strike in a manner that can assist in retaining the latch bolt 24 at the extended, or locked position. For example, according to certain embodiments, the latch bolt 24 can be configured to engage with a door strike such as, for example, a Von Duprin® 499F strike, among others. Additionally, the door strike can be provided in a variety of different types of door frames or mullions, including, for example, the Von Duprin® 4954, 9954, or KR9954 mullions, among other mullions.

During use, depressing the pushbar 26 in a direction generally toward the door 12 can facilitate a rotational displacement of at least the bell cranks 38a, 38b in a first rotational direction (as generally indicated by “r₁” in FIG. 3) from the first position to a second position. Such displacement of the bell cranks 38a, 38b can facilitate a displacement or pulling of at least a portion of the main control link assembly 36 in a first linear direction (d₁) that is generally parallel to the central longitudinal axis 49 of the main control link assembly 36. Such displacement of at least a portion of the main control link assembly 36 in the first linear direction (d₁) can assist in facilitating a displacement of the latch bolt 24 from the extended, or locked, position to the retracted, or unlocked, position. Upon release of the pushbar 26, the main control link spring 40 and/or other biasing elements can assist in at least biasing the bell cranks 38a, 38b to rotate in a second rotational direction (as generally indicated by “r₂” in FIG. 3) so as to return the bell cranks 38a, 38b from the second position to the first position. Additionally, such a return of the bell cranks 38a, 38b from the second position to the first position can coincide with a displacement or pushing of at least a portion of the main control link assembly 36 in a second linear direction (d₂) that is opposite to the first linear direction (d₁) and which is generally parallel to the central longitudinal axis 49 of the main control link assembly 36. Such displacement of at least a portion of the main control link assembly 36 in the second linear direction (d₂) can assist in facilitating a displacement of the latch bolt 24 from the retracted, or unlocked, position back to the extended, or locked, position. For example, according to certain embodiments, as the main control link element 47 of the main control link assembly 36 is displaced in the second direction (d₂), the main control link element 47 can push the latch bolt 24 to displace the latch bolt 24 to the extended, or locked, position.

When the door 12 is closed, and the latch bolt 24 is in the extended, or locked, position to engage the strike, a deadlock mechanism of the exit device 22 can be actuated to provide for deadlocking of the exit device 22. Moreover, when activated, such deadlocking can prevent displacement of at least a portion of a control linkage element 46, including a main control link element 47, in the first direction (d₁) so as to provide resistance against illicit attempts to displace the latch bolt 24 to the retracted, or unlocked, position. The particular manner in which such a deadlocking feature is provided by the deadlock mechanism can vary for different exit devices. For example, such a deadlock mechanism can provide deadlocking features via at least portions of the deadlock mechanism being selectively displaceable to provide barriers or obstacles that directly or indirectly hinder displacement of, or retain the position of, the main control link element 47 to retain the latch bolt 24 in the extended, or locked, position. For example, in the illustrated embodiment, a biasing element 37, also referred to herein as a latch return spring 37, can bias the main control link element 47 generally in the second direction (d₂) such that a deadlock arm 45 can be moved to a position relative to the main control link element 47 that can prevent displacement of at least the main control link element 47 in the opposite first direction (d₁), thereby retaining the latch bolt 24 in the extended position. Further, such a deadlock mechanism can be deactivated via authorized depressing of the pushbar 26, as discussed above.

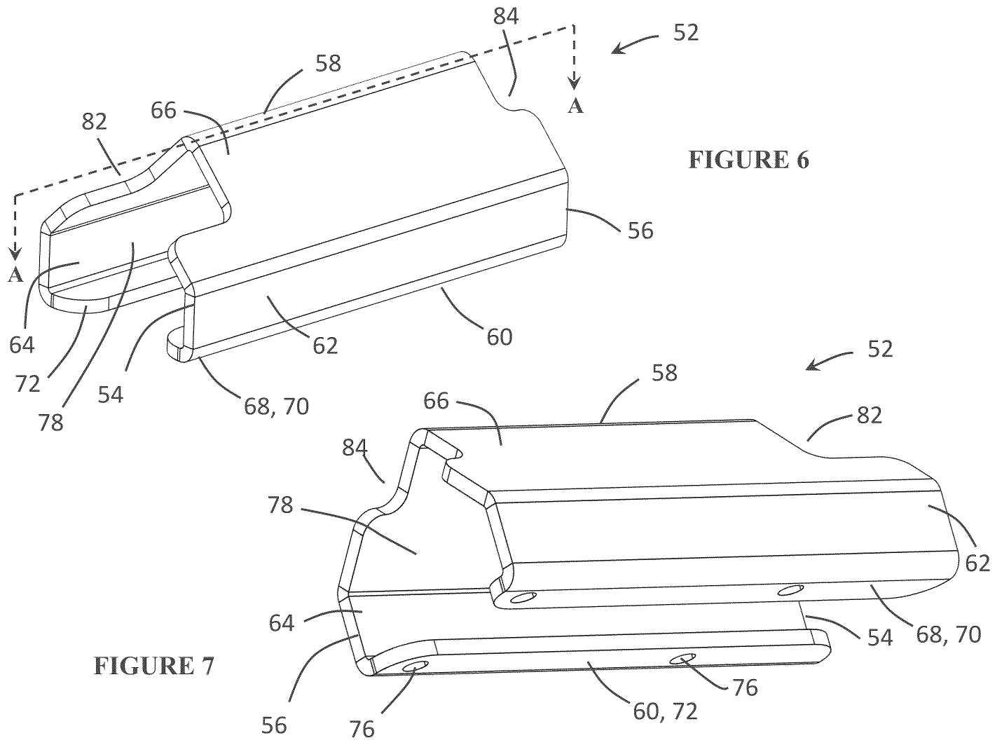

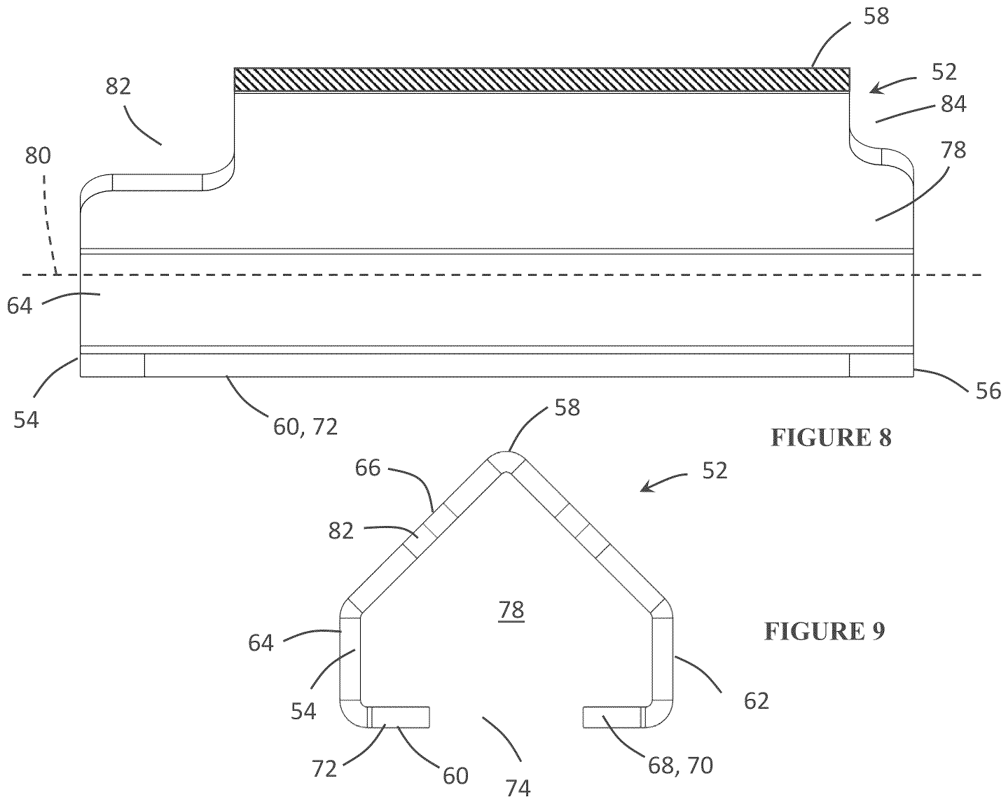

Referencing FIGS. 6-9, either or both the baseplate assembly 32 and the main control link assembly 36 can include one or more shield housings 52 that are configured to at least assist in maintaining an orientation of the main control link assembly 36 in the event the exit device 22 is impacted and/or damaged by a projectile launched from a weapon (e.g., a bullet shot from a firearm). In the absence of the shield housing 52, such damage to the exit device 22 caused by the projectile (e.g., bullet discharged from a firearm) can potentially facilitate a change in the orientation of the main control link assembly 36. For example, the main control link assembly 36 can be, in response to such a projectile striking the exit device 22, rotatably displaced generally in the above-discussed first rotational direction (r₁) such that the central longitudinal axis 49 of the main control link assembly 36 is no longer generally parallel to at least the baseplate 34 and/or to the intended first and second directions of linear displacement (d₁, d₂). As the main control link assembly 36 is directly or indirectly coupled to the latch return spring 37 that is used in connection with providing deadlocking features, such a change in the orientation of the main control link assembly 36 can impair the ability of the latch return spring 37 to at least bias the main control link element 47 in the second direction (d₂) and/or otherwise impede with the deadlocking capabilities of the exit device 22. Such a change in the orientation of the main control link assembly 36 due to damage associated with the exit device 22 being struck by a projectile (e.g., bullet) could therefore potentially deactivate such deadlocking capabilities. Accordingly, embodiments discussed herein include one or more shield housings 52 that are positioned to at least attempt to retain an orientation of the main control link assembly 36 relative to one or more other components of the center case assembly 30 and/or the baseplate assembly 32, including, but not limited to, the baseplate 34. The shield housing(s) 52 can be configured to retain an orientation of the main control link assembly 36 in various manners, including, for example, being configured to restrict relative movement of at least adjacent portions of the main control link assembly 36. For example, according to certain embodiments, the shield housing(s) 52 can be configured to restrict relative movement of the adjacent portion of the main control link assembly 36 to linear movement only in directions that are generally parallel to the above-discussed central longitudinal axis 49 of the main control link assembly 36.

While the one or more shield housings 52 can be positioned at a various locations about the baseplate assembly 32 and/or the main control link assembly 36, according to certain embodiments at least one shield housing 52 can be positioned to at least partially cover or encompass at least a portion of the main control link element 47, main control link spring 40, and/or the above-discussed control pin 44. Additionally, according to certain embodiments, the shield housing 52 can be configured to completely directly envelope, or otherwise encompass, one or more components of the baseplate assembly 32 and/or the main control link assembly 36 alone or in connection with other components, including, for example, in connection with the baseplate 34, while also accommodating movement of the encompassed component relative to the shield housing 52.

The shield housing 52 can linearly extend between a first end 54 and a second end 56 of the shield housing 52 in at least the first direction (d₁), as well as between a top end 58 and a bottom end 60 in a direction that is generally orthogonal to the first direction (d₁). Additionally, the shield housing 52 can include a first wall 62, a second wall 64, a top wall 66, and a base portion 68. The first and second walls 62, 64 can, according to certain embodiments, generally extend from the first end 54 to the second end 56 of the shield housing 52 in a direction that is generally parallel to the first direction (d₁). Moreover, the first and second walls 62, 64 can extend between the first end 54 and the second end 56 of the shield housing 52 in a direction that is parallel to the direction the main control link assembly 36 may be displaced during activation of the exit device 22, including, activation associated with depressing the pushbar 26. The top wall 66 can extend between, and adjoin, an upper portion of the first and second walls 62, 64. In the illustrated embodiment, the base portion 68 can include a first base portion 70 and a second base portion 72, the first base portion 70 inwardly extending from a lower portion of the first wall 62 in a direction generally toward the second base portion 72, and the second base portion 72 can inwardly extend from a lower portion of the second wall 64 in a direction generally toward the first base portion 70. According to the illustrated embodiment, the first and second base portions 70, 72 can generally define a gap 74 therebetween. However, according to other embodiments, the first and second base portions 70, 72 can be adjoined such that at least a portion of the base portion 68 can generally continuously extend between the lower portions of the first and second walls 62, 64. Additionally, according to certain embodiments, the first and second base portions 70, 72 can include one or more apertures 74 configured to receive a mechanical fastener, such as, for example, a bolt, that can assist in mounting the shield housing 52 to an adjacent component of the baseplate assembly 32 and/or to the main control link assembly 36, including, for example, to the baseplate 34.

The top wall 66 of the shield housing 52 can have various configurations, including, for example, different shapes and sizes. According to certain embodiments, the top wall 66 can comprise a plurality of walls that can extend in diverging directions from an apex of the top wall 66 where the plurality of walls of the top wall 66 are adjoined, to a different one of the first and second walls 62, 64, as seen for example, in at least FIG. 6. According to such an embodiment, the top wall 66 can have a generally triangular configuration. However, the top wall 66 can have a variety of sloped or non-sloped (e.g., flat) configurations, including, for example, being a single wall having a sloped or non-sloped configuration as the top wall 66 extends between the first and second sidewalls 62, 64. Additionally, the top wall 66 may, or may not, have a generally curved, rounded and/or polygonal configuration.

The first wall 62, second wall 64, top wall 66, and base portion 68 of the shield housing 52 can generally define a cavity 78 that can extend through the shield housing 52, including through the first and second ends 54, 56 of the shield housing 52. The cavity 78 can thus provide a through-hole that extends through the length of the shield housing 52 in at least the first direction (d₁). Moreover, according to certain embodiments, the cavity 78 can generally extend along a central longitudinal axis 80 that is generally parallel to the above discussed central longitudinal axis 49 of the main control link assembly 36.

The size of the cavity 78 can be configured to house, and shield, at least a portion of the main control link assembly 36, including, for example, the main control link spring 40, the control pin 44, and/or a control linkage element 46 at least when the latch bolt 24 is in the extended, or locked, position. Optionally, such positioning of the shield housing 52, as well as at least the hardened steel construction of the shield housing 52, can provide a barrier against a projectile (e.g., bullet) launched from a weapon (e.g., firearm) that enters into the interior of the exit device 22 from passing into the cavity 78. Moreover, according to certain embodiments, the shield housing 52 can be configured to assist in shielding at least portions of the main control link assembly 36, including, for example, the main control link element 47, from being struck by the launched projectile (e.g., bullet). According to such embodiments, at least a portion of the shield provided by the shield housing 52 for components housed within the cavity 78 can be supplemented by other components of the access control device 10, including for example, at least the portion of the baseplate 34 positioned adjacent to the gap 74 and/or to the mounting assembly 28.

The shield housing 52 can also be configured to accommodate displacement of at least a portion of the main control link assembly 36, including, for example, a portion of the main control link element 47, main control link spring 40, and control linkage elements 46 that are housed within the cavity 78 when the latch bolt 24 is in the extended position to at least temporarily exit the cavity 78, and thus exit the shield housing 52, as the latch bolt 24 is displaced to the retracted, or unlocked, position. Similarly, the shield housing 52 can be configured to allow at least another portion of the main control link assembly 36 to, at least temporarily, enter the cavity 78 as the latch bolt 24 is displaced to the retracted, or unlocked, position, as well as accommodate egress of that other portion of the main control link assembly 36 from the cavity 78 as the latch bolt 24 is displaced back to the extended, or locked, position. However, as previously discussed, the shield housing 52 can be sized to restrict the direction of such displacement of the main control link assembly 36 such that, in the event the exit device 22 is damaged by impact from a projectile discharged by a weapon (e.g., bullet shot from a firearm), the shield housing 52 can at least assist in retaining the orientation of the main control link assembly 36.

In the illustrated embodiment, one or both of the first and second ends 54, 56 of the shield housing 52 can include a window 82, 84 that can be sized to prevent the shield housing 52 from interfering with movement of at least adjacent portions of the main control link assembly 36 during at least displacement of the latch bolt 24 between the extended and retracted positions. For example, as seen in at least FIG. 6, the first end 54 of the shield housing 52 can include a first window 82 that generally extends through at least a portion of the top portion 66 of the shield housing 52 in a direction generally toward the second end 56 of the shield housing 52. Similarly, the illustrated shield housing 52 can also include, at the second end 56 of the shield housing 52, a second window 84 that generally extends through at least a portion of the top portion 66 of the shield housing 52 in a direction generally toward the first end 54 of the shield housing 52. As also seen in FIGS. 6 and 7, the depth of the first window 82 (i.e., the distance the first window 82 extends from the adjacent first end 54 toward the second end 56) is greater than the corresponding depth of the second window 84 (e.g., the distance the second window 84 extends from the adjacent second end 56 toward the first end 54). Such differences in depths of the first and second windows 82, 84, as well as any corresponding differences in the size and shapes of the first and second windows 82, 84 can be attributed to differences in the configurations, including sizes, of the corresponding adjacent portions of the main control link assembly 36.

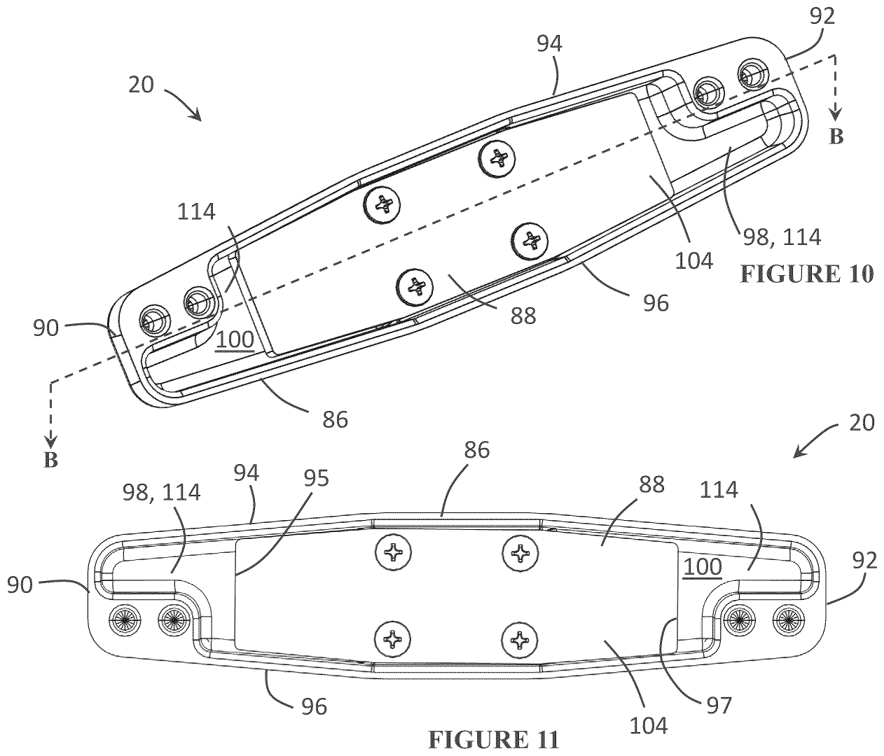

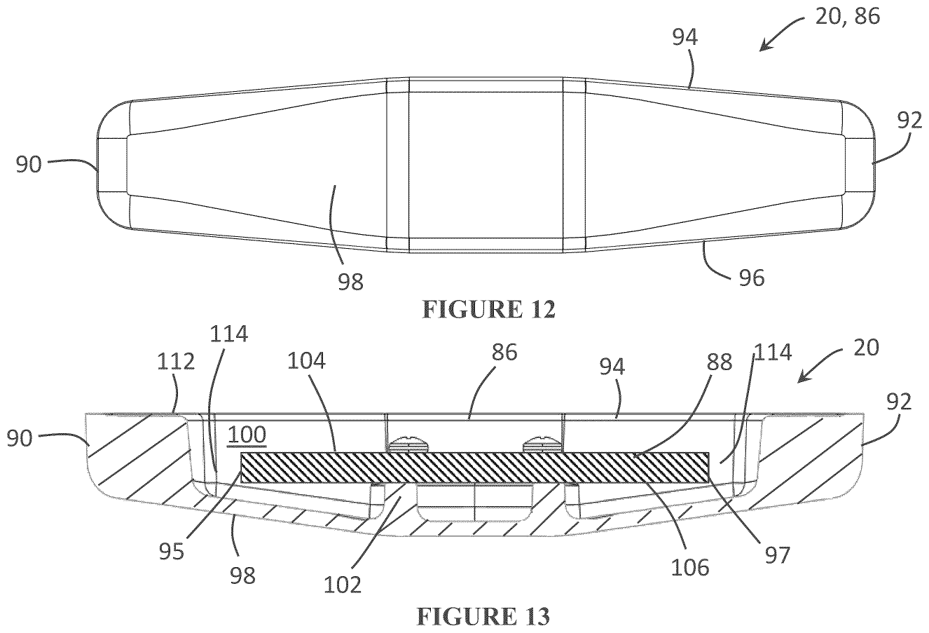

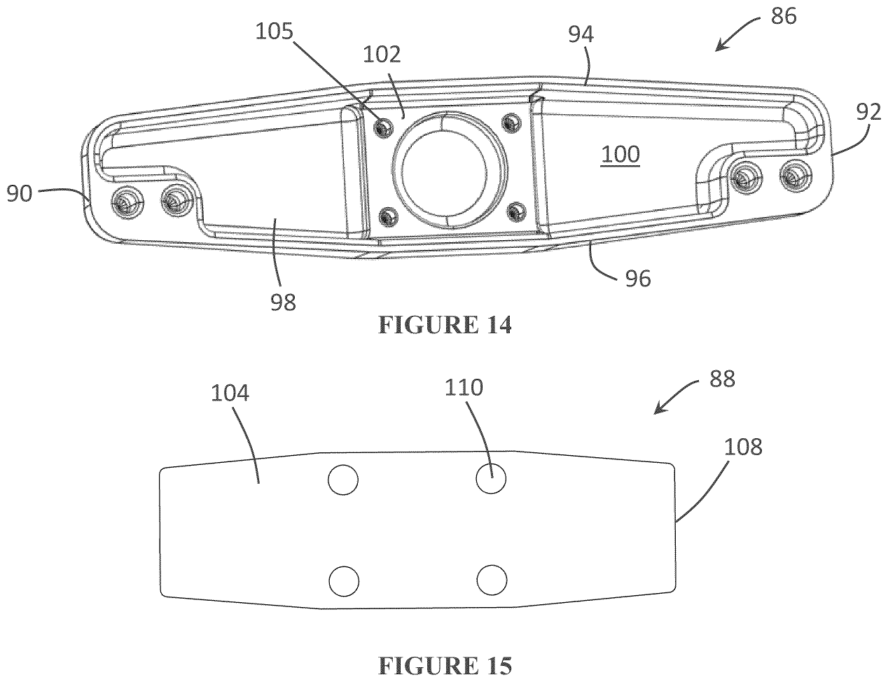

Turning to FIGS. 10-15, the illustrated trim assembly 20 includes a trim portion 86 and one or more armor bodies 88. The trim portion 86 can extend between opposing first and second end walls 90, 92, as well as between opposing first and second sidewalls 94, 96. The trim portion 86 can also include a face wall 98 that generally extends between upper portions of the first and second end walls 90, 92 and sidewalls 94, 96. As seen in at least FIG. 12, according to certain embodiments, the face wall 98 may not include any openings or apertures that may extend through the face wall 98. Moreover, at least the trim portion 86 of the trim assembly 20 may be configured such that the trim assembly 20 is an exit only device. Thus, according to such embodiments, the face wall 98 may not have any openings or apertures configured receive a key or other device used to unlock the access control device 10 and/or used to facilitate displacement of the latch bolt 24 from the extended, or locked, position. Additionally, the face wall 98, as well as the first and second end walls 90, 92 and sidewalls 94, 96 can generally define an interior area 100 of the trim assembly 20 that can accommodate placement of one or more armor bodies 88.

According to certain embodiments, the trim portion 86 can be constructed from a first material while the armor body 88 is constructed from a second material, the first material being different from the second material. For example, the first material of the trim portion 86 can be a cast material, including, for example, one or more of a cast steel, cast brass, or cast bronze, among other cast materials. Conversely the second material may be a hardened material, including, for example, hardened steel that, compared to at least the first material, provides enhanced impact resistance and/or absorption properties, including, for example, with respect to an impact associated with a projectile (e.g., bullet) launched, including shot, from a weapon (e.g., firearm). Moreover, unlike the first material of the trim portion 86, the hardened steel configuration of the armor body 88 can be configured to resist, if not prevent, a passage of a projectile (e.g., bullet) through the trim assembly 20. Additionally, the armor body 88 can have sufficient material thickness, including, with respect to thickness of the material between the opposing first and second sides 104, 106 of the armor body 88, to further assist with the resistance and absorption characteristics of the armor body 88 to an impact of the armor body 88 by a projectile released from a weapon (e.g., bullet shot from a firearm). For example, according to certain embodiments, the armor body 88 can be approximately a one-quarter inch (¼″) thick plate of hardened steel.

As seen in at least FIGS. 13 and 15, the armor body 88 can include a first side 104 and an opposing second side 106, and can have a shape and/or configuration that is generally defined by an outer perimeter 108 of the armor body 88. Moreover, the outer perimeter 108 of the armor body 88 can be configured to matingly conform to the size and shape, including configuration, of at least a portion of the interior area 100 of the trim portion 86 such that the armor body 88 can be housed within the interior area 100. As seen in at least FIG. 13, the armor body 88 can have a configuration, including, for example, a shape and size, such that when the armor body 88 is securely coupled to the trim portion 86, the armor body 88 is recessed within the interior area 100. For example, according to certain embodiments, the first side 104 of the armor body 88 can be inwardly offset from a lower portion 112 of the trim portion 86 such that the armor body 88 does not protrude outside of the interior area 100, which can, at least partially, be defined by an outer perimeter wall 101 of the trim portion 86. Additionally, according to certain embodiments, the second side 106 of the armor body 88 can, optionally, be offset from at least a portion of the face wall 98 by a spacer 102. Such an optional feature can provide a space between at least a portion of the second side 106 of the armor body 88 and an adjacent surface of the face wall 98. Additionally, the spacer 102 can provide an area with sufficient material thickness such that apertures 105 can be included in the trim portion 86 that can receive, and retain, a secure coupling with one or more fasteners that pass through corresponding apertures 110 in the armor body 88 and are used to securely couple, including attach, the armor body 88 to the trim portion 86.

According to other embodiments, the spacer 102 can be removed or eliminated, and the face wall 98 can instead have a sufficient material thickness to accommodate placement of the apertures 105 for maintaining an associated secure connection with the corresponding mechanical fasteners used to couple the armor body 88 to the trim portion 86. Additionally, or alternatively, rather than having a trim portion 86 and a separate armor plate 88, according to other embodiments, the trim portion 86 and armor body(ies) 88 can form a monolithic structure that can be formed of the above-discussed hardened steel of the second material.

The armor body 88 can further be sized such that the armor body 88 does not extend the entire length of the interior area 100 in the direction between the first and second end walls 90, 92 of the trim portion 86. For example, as seen at least in FIGS. 11 and 13, opposing ends 95, 97 of the armor body 88 can each be separated from an adjacent portion of the first and second end walls 90, 92 by a recess 114. Such sizing of the armor body 88 can be configured to shield at least certain portions of the exit device 22 while minimizing additional weight contributed to the trim assembly 20 by the armor body 88, and further provide a savings with respect to material costs. For example, according to certain embodiments, the armor body 88 can have a size, as well as a position, such that when the access control device 10 is secured to the door 12, the armor body 88 is at a location within the trim assembly 20 at which the armor body 88 is generally aligned with the latch return spring 37 of the center case assembly 30, among other portions of the center case assembly 30, that can be positioned at the opposite side of the door 12. Moreover, the armor body 88 can have a size and placement location within the trim portion 86 that can correspond to the armor body 88 providing a shield to at least a portion of the center case assembly 30 on the opposing side of the door 12, including, for example, the latch return spring 37. Such a configuration and placement of the armor body 88 relative to the exit device 22 can facilitate the armor body 88 assisting in preventing damage to the center case assembly 30 or other portion of the exit device 22 by a projectile launched from a weapon (e.g., bullet from a firearm) that could otherwise cause damage to the access control device 10 in a manner that could contribute to an unauthorized ability to forcibly open the associated door 12.

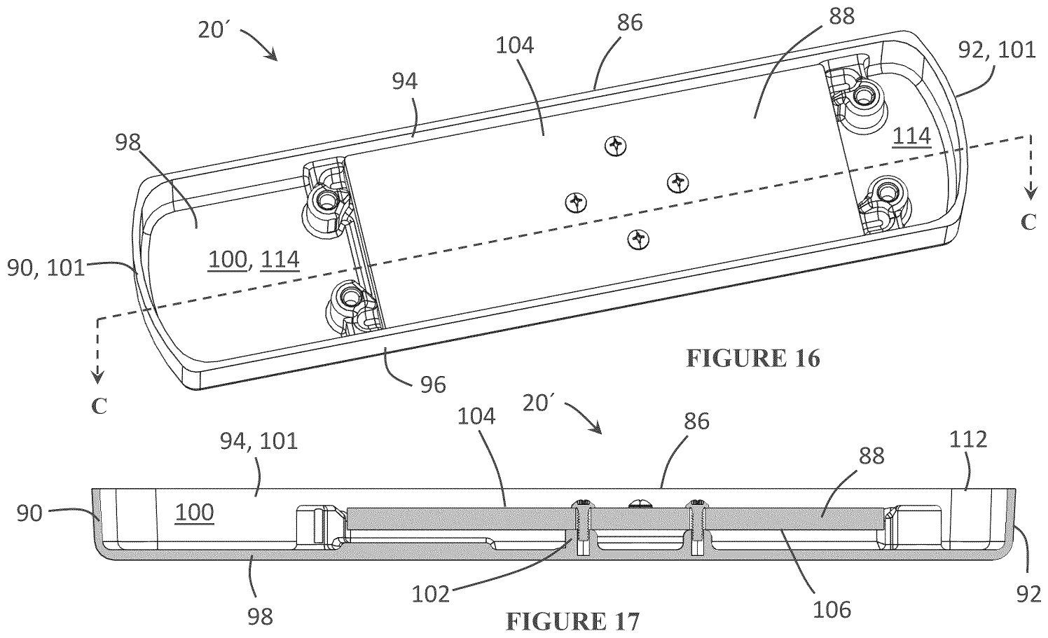

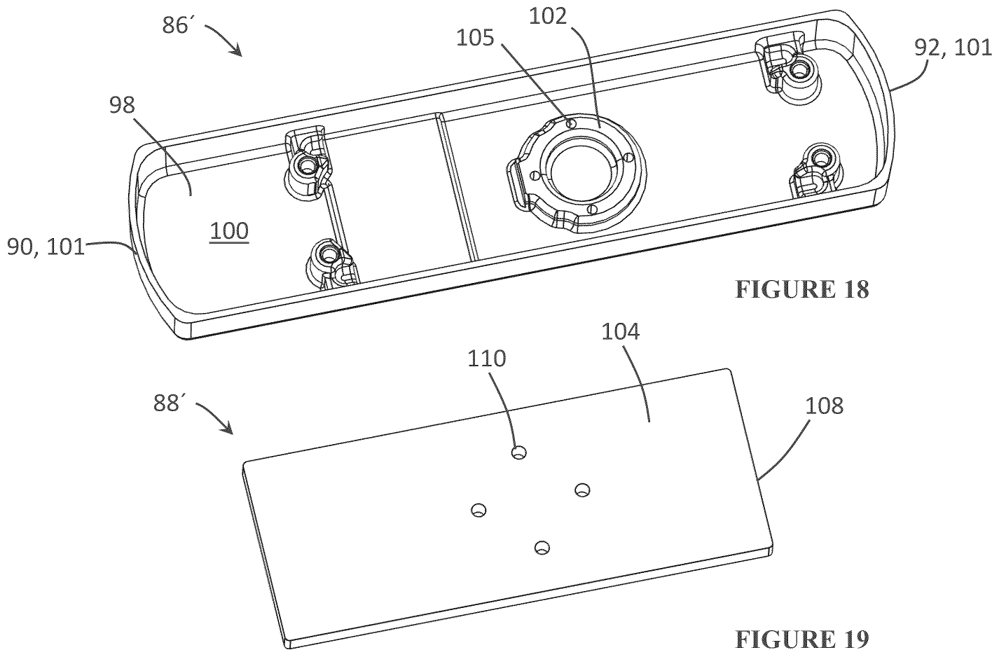

FIGS. 16-19 illustrate another embodiment of a trim assembly 20′ having features similar to the trim assembly 20 shown in at least FIGS. 10-15 but in which the trim portion 86′ and the armor body 88′ have different shapes and sizes. Moreover, in this second embodiment of the trim assembly 20′, the different shapes and sizes of the trim portion 86′, and thus associated interior area 100, contribute to the different shape and size of the armor body 88′. However, aside from differences in the shapes and sizes of the trim portion 86′ and the armor body 88′, this second trim assembly 20′ embodiment can, at least generally, have features similar to those discussed above with respect to the trim assembly 20 shown in at least FIGS. 10-15 and the use of similar reference numbers in FIGS. 16-19.

While the inclusion of one or more armor bodies 88 has been discussed herein with respect to the trim assembly 20, 20′, additionally, or alternatively, such an armor body(ies) 88 can be incorporated into one or more portions of the exit device 22. For example, according to certain embodiments, an armor body similar to the armor body 88 discussed above, with a different outer perimeter 108 shape, can be positioned along the baseplate 34 at various different locations. For example, according to certain embodiments, one or more armor bodies can be positioned along the baseplate 34 and at the same side, opposite side, or combination thereof, as the baseplate 34 and/or the main control link assembly 36. Moreover, one or more armor bodies can be placed on the exit device 22 at one or more locations where the main control link assembly 36, or portions thereof, extend along the baseplate assembly 32. Such an inclusion of armor bodies with the exit device 22 can be in addition to, or in lieu of, the inclusion of one or more shield housings 52. Thus, for example, according to certain embodiments, the baseplate assembly 124 can further include one or more armor bodies 88 positioned along one or both sides of the baseplate 34 at locations adjacent to, or otherwise aligned with, at least a portion of the main control link assembly 36, including, but not limited to, one or more of the main control link spring 40, control pin 44, and/or control linkage elements 46, including a portion of the main control link element 47. Additionally, or alternatively, one or more armor bodies can be positioned along a surface of the center case assembly 30, including, for example, coupled to the center case 48 and/or chassis 50. Further, such armor bodies of the exit device 22 can, similar to the armor bodies 88 of the trim assembly 20, be constructed from a hardened steel, including, but not limited to, hardened steel plate.

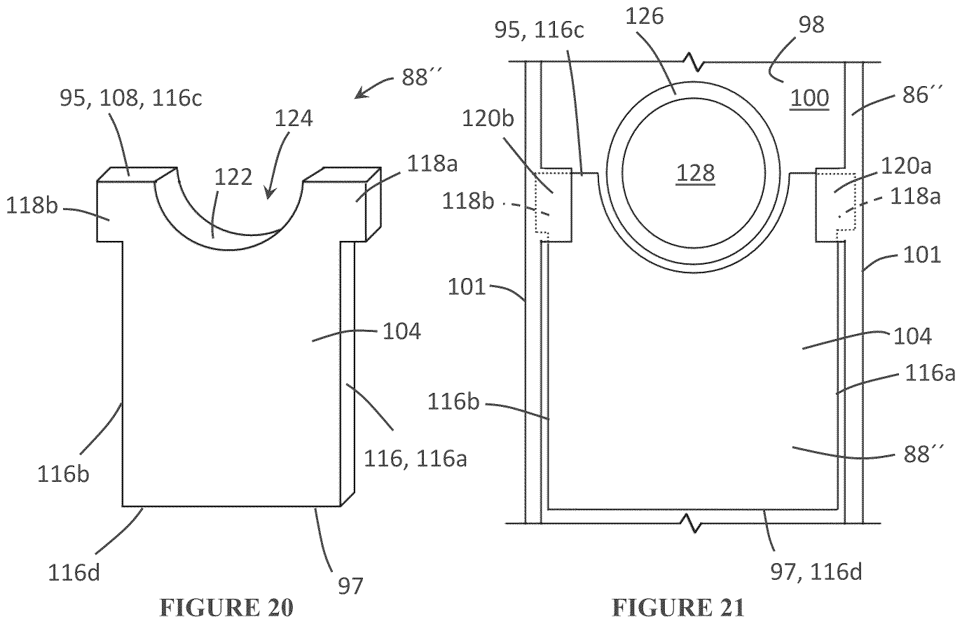

Referring now to FIGS. 20 and 21, FIG. 20 illustrates a front side perspective view of another exemplary armor body 88″ configured for incorporation within trim assembly 20, while FIG. 21 depicts the armor body 88″ installed within a trim portion 86″ of a trim assembly 22.

The armor body 88″ may have a configuration that is generally similar to the armor bodies 88 and 88′ previously disclosed with reference to at least FIGS. 15 and 19. In particular, the armor body 88″ can be fabricated from the above-discussed second material, and, moreover, a hardened material such as hardened steel. Accordingly, the armor body 88″ is also adapted to provide enhanced impact resistance and/or impact absorption characteristics suitable for mitigating effects from projectiles, such as bullets or shot, discharged from weapons (e.g., firearms).

The perimeter 108 of the armor body 88″ can include a plurality of sidewalls 116, including, for example, a first sidewall 116a, a second sidewall 116b, a top sidewall 116c, and a bottom sidewall 116d. The first and second sidewalls 116a, 116b can extend between the top sidewall 116c and the bottom sidewall 116d. The top sidewall 116c can be positioned at, or adjacent, to a first end 95 of the armor body 88″, while the bottom sidewall 116d can be located at, or adjacent to, a second end 97 of the armor body 88″.

In certain embodiments, the armor body 88″ further includes one or more shoulders 118a, 118b configured to assist in locating and orienting the armor body 88″ within an interior area 100 of the trim portion 86″. For example, the armor body 88″ can include a first shoulder 118a that extends outwardly from the first sidewall 116a at, or adjacent to, the first end 95 of the armor body 88″, while an opposing second shoulder 118b can extend outwardly from the second sidewall 116b at, or adjacent to, the first end 95. As shown in FIG. 20, the upper portions of the first and second shoulders 118a, 118b may, according to certain embodiments, form a portion of, or be integrally joined to, the top sidewall 116c.

Although the depicted shoulders 118a, 118b have generally similar configurations and are located at similar positions on opposing sides of the armor body 88″, the shoulders 118a, 118b may alternatively have different configurations and/or be positioned in different locations. Further, while a single shoulder 118a, 118b is illustrated as extending from each of the first and second sidewalls 116a, 116b, according to other embodiments, the number, position, and/or configuration of shoulders extending from the sidewalls 116a, 116b can vary and may differ between sidewalls 116a-d. Moreover, the particular sidewall(s) 116a-d from which one or more shoulders 118a, 118b extend, as well as the number of sidewalls 116a-d and/or the combination of sidewalls 116a-d, can vary. For example, in certain embodiments, one or more shoulders 118a, 118b may extend from one sidewall 116a-d or a plurality of the sidewalls 116a-d.

As illustrated in FIG. 21, the trim portion 86″ may include corresponding tabs 120a, 120b situated within, or extending above, the interior area 100 and offset from the rear surface of the face wall 98. Such an offset can define a recess configured to selectively receive the respective shoulders 118a, 118b therein. The arrangement of tabs 120a, 120b and the face wall 98 can cooperate to retain the shoulders 118a, 118b between the tabs 120a, 120b and the face wall 98, thereby at least assisting in securing the position of the armor body 88″ within the interior area 100 of the trim portion 86″.

Optionally, the top sidewall 116c of the armor body 88″ can include a concavely shaped recess wall 122 that can extend inwardly from one of the first end 95, the second end 97, and/or a sidewall 116 of the perimeter 108. For example, in the illustrated embodiment the recess wall 122 downwardly extends from the top sidewall 116c. The recess wall 122 can define a recess 124 adapted to receive placement of at least a portion of a circular shaped aperture wall 126 of the trim portion 86″ when the armor body 88″ is operatively positioned within the interior area 100, including when the shoulders 118a, 118b are engaged between the corresponding tabs 120a, 120b and the face wall 98. The aperture wall 126 can define an aperture 128 that is configured to receive a hardware component of an access control device 10, such as, for example, a key cylinder, lock cylinder, spindle associated with a lever or handle, or other related components.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. An access control device comprising:
a pushbar;
a latch bolt displaceable between an extended position and a retracted position;
a baseplate;
a main control link assembly positioned along the baseplate and coupled to the pushbar; and
a shield housing having a cavity that extends through the shield housing, the shield housing being coupled to the baseplate and at least partially encompassing a first portion of the main control link assembly within the cavity when the latch bolt is at the extended position, at least a portion of the first portion of the main control link assembly being displaced out from the cavity with a displacement of the latch bolt from the extended position to the retracted position, the shield housing being configured to retain an orientation of at least a portion of the main control link assembly relative to other components of the access control device in the event the main control link assembly is damaged by impact from a discharged projectile.

2. The access control device of claim 1, wherein the first portion of the main control link assembly comprises at least one of a main control link element and a control pin.

3. The access control device of claim 1, wherein the cavity is defined by a first wall, a second wall, a top wall, and a base portion of the shield housing, wherein the first wall and the second wall extend between a first end and a second end of the shield housing, and wherein the cavity extends through the first end and the second end along a longitudinal centerline of the shield housing that is generally parallel to a longitudinal centerline of the main control link assembly.

4. The access control device of claim 3, wherein the top wall comprises a plurality of walls that are arranged in a triangular configuration.

5. The access control device of claim 3, wherein the first end of the shield housing includes a first window that is in fluid communication with the cavity, the first window extending at least through a first portion of the top wall.

6. The access control device of claim 5, wherein the second end of the shield housing includes a second window that is in fluid communication with the cavity, the second window extending at least through a second portion of the top wall.

7. The access control device of claim 1, wherein the shield housing is constructed from a plate of hardened steel, and wherein the shield housing is attached to the baseplate.

8. The access control device of claim 1, wherein the cavity is parallel to a direction of displacement of at least a portion of the main control link assembly as the latch bolt is displaced from the extended position to the retracted position.

9. The access control device of claim 1, further comprising an armor body coupled to the baseplate, the armor body constructed from a hardened material.

10. The access control device of claim 1, further comprising a trim assembly, the trim assembly comprising:
a trim portion constructed of a first material, the trim portion having a sidewall and a face wall, the sidewall extending around a perimeter of the trim portion, the face wall extending across an upper portion of the perimeter of the trim portion, the sidewall and the face wall defining an interior area of the trim portion; and
at least one armor body constructed of a second material that is different than the first material, the at least one armor body being housed within the interior area of the trim portion, the at least one armor body being coupled to the trim portion by one or more mechanical fasteners,
wherein the second material is a hardened steel.

11. The access control device of claim 10, wherein the at least one armor body comprises a plate of hardened steel.

12. The trim assembly of claim 10, wherein the at least one armor body comprises a plurality of apertures each configured to receive the one or more mechanical fasteners.

13. The access control device of claim 10, wherein the trim assembly does not include a key cylinder, a handle, or a lever, and wherein the face wall does not include any openings or apertures that extend through the face wall.

14. The access control device of claim 10, wherein the sidewall of the trim portion comprises a first end wall, a second end wall, a first sidewall, and a second sidewall, and wherein the at least one armor body extends from the first sidewall to the second sidewall.

15. The access control device of claim 10, wherein the at least one armor body is offset from the face wall by a spacer.

16. The access control device of claim 10, wherein the at least one armor body is inwardly offset from a lower portion of the trim assembly.

17. The access control device of claim 10, further comprising a second armor body coupled to the baseplate, the second armor body constructed from a third hardened material.

18. The access control device of claim 17, wherein the shield housing and the second armor body are constructed from the same grade of hardened steel.

19. An access control device comprising:
an exit device comprising a shield housing, the shield housing having a cavity extending through the shield housing, the cavity configured to at least partially encompass and retain an orientation of a main control link assembly when the exit device is subjected to impact from a projectile; and
a trim assembly comprising a trim portion and at least one armor body, the trim portion having a sidewall and a face wall defining an interior area, the armor body being constructed of a hardened material and housed within the interior area of the trim portion, the armor body positioned to provide protection to components of the access control device against damage from impact by a projectile.

20. An access control device comprising:
a trim assembly comprising a trim portion and at least one armor body,
the trim portion having a sidewall and a face wall, the sidewall extending around a perimeter of the trim portion and the face wall extending across at least a portion of the perimeter to define an interior area of the trim portion, and
the at least one armor body housed within the interior area of the trim portion, the armor body being constructed from a hardened material that is different from a material of the trim portion, wherein the armor body is positioned to provide projectile impact resistance to at least one protected component of the access control device.
